(19) United States
(12) Patent Application Publication
(10) Pub. No.: US 2005/0084664 A1
(43) Pub. Date: Apr. 21, 2005

(54) Element with very high mechanical resistance and high vibration absorption and method for implementing the same

(76) Inventor: Alfonso Branca, Milano (IT)

Correspondence Address: The Firm of Karl F Ross, 5676 Riverdale Ave Box 900, Riverdale (Bronx), NY, 10471, US

(21) Appl. No.: 10/501,036

(22) PCT Filed: Dec. 18, 2002
(86) PCT No.: PCT/EP02/14469

(30) Foreign Application Priority Data
Jan. 8, 2002 (IT) MI2002A000010

(51) Int. Cl. B32B 7/02

(52) U.S. Cl. 428/217

(57) ABSTRACT

Element (1) with very high mechanical resistance and high vibration absorption, comprising at least one internal core (20) composed of at least one first material (2) having predominantly high mechanical characteristics, and united, through chemical bonding only, with at least one second material having predominantly highly elastic characteristics; the embodiment method consists in automatically uniting through chemical bonding a first material with predominantly high mechanical characteristics with at least a second material (3) with predominantly highly elastic characteristics in order to form a core (20) to be coated with at least a third material (11).

### CROSS REFERENCE TO RELATED APPLICATIONS

This application is a national stage of PCT/EP02/14469 filed 18 Dec. 2002 and is based upon Italian national application Mi2002A000010 filed 8 Jan. 2002 under the International Convention.

### FIELD OF THE INVENTION

The present invention relates to an element with high mechanical strength and high vibration absorption, and to a method of making the same.

### BACKGROUND OF THE INVENTION

The element according to the present invention may be used preferably for handles on tools such as hammers, sledge hammers, tools used for buffeting trees for fruit-picking, axes, and the like. It can also be used for manufacturing any structures that require high mechanical and workability characteristics and high vibration absorption characteristics at the same time, combined with special physical properties such as resistance against corrosion, absence of hygroscopy and porosity, shrinking and dilatation.

It is a well known fact that elements that must be held in the hand for use, such as handles and the like, that possess mechanical strength and are able to absorb vibration, are traditionally manufactured in wood to guarantee good technological performance because of wood's fibrous nature (splitting and cutting capacity, flexibility, cleanliness and plasticity levels) combined with physiological properties (porosity, density, hygroscopy, homogeneity, shrinking and dilatation) and good vibration absorption.

However, in certain cases the mechanical properties of wood (traction, compression, bending, cutting capacity, torsion) can be insufficient for certain applications, for example when the predominant stress involves strong impact (impact stress) or flexion.

In these cases, results have shown that the wooden element used as a handle in a wide variety of work sectors can break because of its morphology.

Moreover, with wear, wood can splinter, harming the user, and when subject to atmospheric agents (for example, when left outside) because it is hygroscopic it tends to shrink or dilate thus provoking play between the wooden element and the other elements attached to it that are generally made of metal.

To overcome these problems, other types of handle have been manufactured with a fiberglass-reinforced plastic core that acts as a coating and to provide a correct grip.

However, these solutions have also created many problems, mainly due to the fact that the fiberglass core transmits the vibrations provoked by tool use, and the vibrations are transmitted to the user's arm, almost without any cushioning, provoking consequential damage to the arm.

Moreover, when fiberglass is used for handles and the like, special adhesives must be used to create correct bonding between the various components and this leads to a considerable extension of production time, the need for more labor, and an increase in production costs, as well as the fact that all adhesives have varying aging times which influence the chemical and physical characteristics.

The use of adhesives can be eliminated, but this means a long preparation time for the mold in which the various components are arranged.

This situation has a considerable influence on production costs, and produces unacceptable quantity levels.

### OBJECT OF THE INVENTION

It is an object of the invention to provide an element with very high mechanical strength, and high vibration absorption, and a method of making the same, which eliminate the technical problems encountered in prior art.

Another object is to provide an element that, as well as having excellent chemical and physical characteristics, is also able to cushion the vibrations that are generated during use, very efficiently.

A further object of the invention is to provide an element and a method for producing said element without the need for specialize labor, and that can be manufactured in a short time and using automated production methods.

A further object of the invention is to provide an element that is extremely reliable because of its long-lasting physical and chemical characteristics that can be designed so that it is not subject to degeneration because of the inevitable deterioration of some of its components, such as the adhesive.

A last, but by no means least, object of the invention is to provide an element and a production method that are basically economical, and that can be performed using a pultrusion method that is basically automatic.

### SUMMARY OF THE INVENTION

These and other objects, according to the present invention are attained by providing an element with high mechanical strength and high vibration absorption which comprises at least one internal core composed of at least one first material with predominantly very high mechanical strength, combined through chemical bonding only with at least one second material with predominantly very high elastic characteristics.

The present invention also is a method of producing an element with very high mechanical strength and high vibration absorption levels, which consists of automatically uniting through chemical bonding, a first material with predominantly very high mechanical strength, with at least one second material with predominantly very highly elastic characteristics in order to form a core that can be coated with at least one third material. The first and second materials can be bonded without the use of adhesives. The first material can be composed of a thermoplastic resin in which a plurality of natural and/or synthetic fibers are embedded. The synthetic fibers can be composed of glass fiber.

The second material can be composed of an elastomeric polymer. The thermoplastic resin-can be an engineered polyurethane thermoplastic polymer, industrially recognized under the name ETPU (engineering thermoplastic polyurethane). The second material can alternatively be thermoplastic polyurethane.

The core can covered with a layer in a third material composed of an elastomeric polymer. This core can comprise at least two elongated elements created using pultrusion. The elongated elements can be rod-shaped or disk-shaped.

According to a feature of the invention, a bearing made of the second material is inserted between the elongated elements. The rod-shaped elements can have at least one flat surface and one curved surface, the bearing being inserted between the flat surfaces of the adjacent rod-shaped elements.

The method of the invention for implementing an element with high mechanical strength and high vibration absorption, comprises the automatic union through chemical bonding of a first material having predominantly high mechanical characteristics, with at least a second material having predominantly highly elastic characteristics, in order to form a core which is coated with at least one third material. The union between the first and second material occurs without the use of an adhesive, but with the application of heat at an established temperature.

The material can be composed of a thermoplastic resin in which a plurality of natural and/or synthetic fibers are embedded. The synthetic fibers are composed of glass fiber and the second material can be composed of thermoplastic polyurethane, especially engineered polyurethane thermoplastic polymer, industrially recognized under the name ETPU (engineering thermoplastic polyurethane) or an elastomeric polymer, preferably is of polyurethane type.

The method can include at least one stage in which the first material is obtained through pultrusion. The method preferably includes at least one coextrusion stage at an established temperature to unite the first material with the second material and includes a thermoforming stage to model the third material into an ergonomical shape.

### BRIEF DESCRIPTION OF THE DRAWING

In the drawing:

FIG. 1 shows a cross section of an element defined as a handle according to the finding, and, shown in dotted lines, a tool which in this case purely as an example, is shown as the head of a hammer; and

FIGS. 2 and 3 show respectively in cross section and in perspective, a different embodiment of the element from that in FIG. 1.

### SPECIFIC DESCRIPTION

With reference to the above-mentioned Figures, the illustrated element with high mechanical strength and high vibration absorption is identified in all Figures with the reference numeral 1.

Element 1, which, as has been stated above, can preferably be an element used as a handle for certain tools, or used for buffeting plants or the like, comprises at least one internal core 20, composed of at least one first material 2 with predominantly very high mechanical strength combined through chemical bonding only and without the use of adhesives with at least one second material 3, with predominantly very highly elastic characteristics.

In particular, the structure of a tool handle will be described hereinbelow as a preferred but nonlimiting embodiment, taking into account, as has been previously stated, that any element that requires the above-mentioned chemical and physical characteristics can also be produced for other uses.

In the case of a tool handle for example, the first material 2 is used to form two or more rod-shaped elements 4 that are substantially the same length as the handle to be manufactured.

The second material 3 is inserted between these rod-shaped elements as will be further described below, to form a real cushion 5 to absorb vibrations that tend to be transmitted along the two rod-shaped elements when the handle is subjeced to impact involved during tool use.

Advantageously, the core 20, is obtained by simply combining the first material 2 with the second material 3 through chemical bonding obtained with the application of heat at an established temperature and without the use of adhesives between the first and second material, or through the use of an adhesive in the case of adhesion incompatibility between the two materials.

This simplifies and speeds up the creation of the core 20, and also permits the creation without the need for specialized labor for the production preparation, providing considerable advantages because of the large reduction in cost and time.

Suitably the first material (such as TPV, PP, PET) is made of a thermoplastic resin in which a plurality of natural or synthetic fibers are embedded (e.g. glass fiber), and the second material is made of an elastomeric polymer such as thermoplastic polyurethane.

As an example, the first material can be an engineered polyurethane thermoplastic polymer, industrially recognized under the name ETPU (engineering thermoplastic polyurethane) and the second material comprises an elastomeric polymer, preferably polyurethane type.

Element 1 can also be coated over the core 20, with a covering layer 6, made of an elastomeric polymer.

Advantageously, the rod-shaped elements 4, are produced using a pultrusion method.

A coextrusion head is used to combine in a linear and continuous manner the two rod-shaped elements 4, produced with pultrusion, with the second material 3, to form the cushioning element 5.

For example, the coating layer 6, made of the third material composed of an elastomeric polymer can be applied onto the core 20 by a second coextrusion head.

In the case of handles shaped differently from the cylindrical form, for example ergonomically shaped handles, the third material in elastomeric plastic 6, can undergo a thermoforming stage.

In a constructive variant, the chemical bonding between the first and second material can be performed directly during the impregnation stage of the glass fiber with the thermoplastic resin.

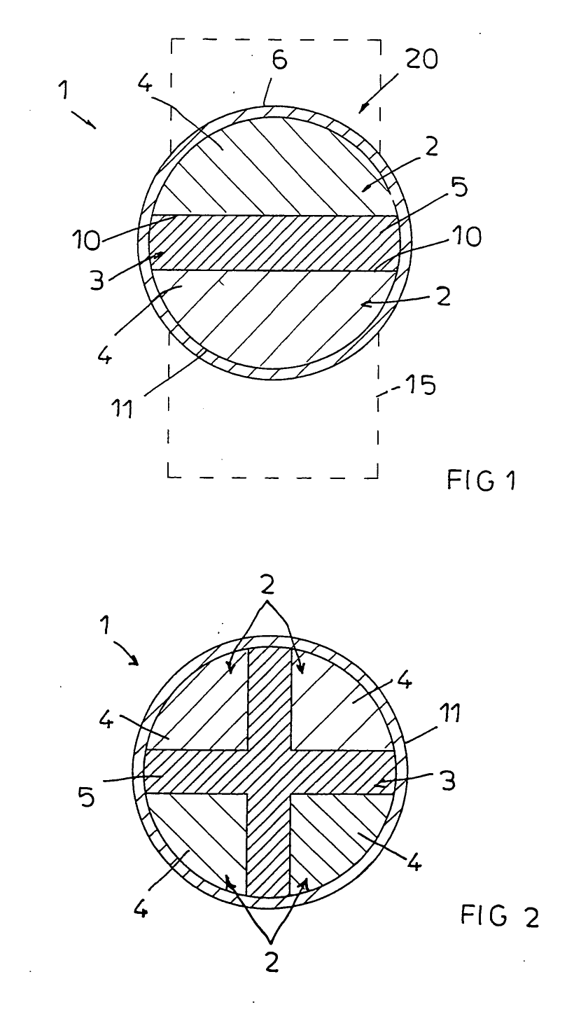

In the case illustrated in FIG. 1, each of the rod-shaped elements 4, has a flat surface 10, and a curved surface 11.

This means that the cushion 5, made from the second material, can be inserted between the two flat surfaces 10.

With this solution, during strong impact the main flexion in the handle will occur along the two flat surfaces 10 that will form a sliding movement between both elements due to the elasticity of the cushion inserted between the two flat surfaces.

At the same time, the vibrations will be cushioned and will not be able to spread along the handle.

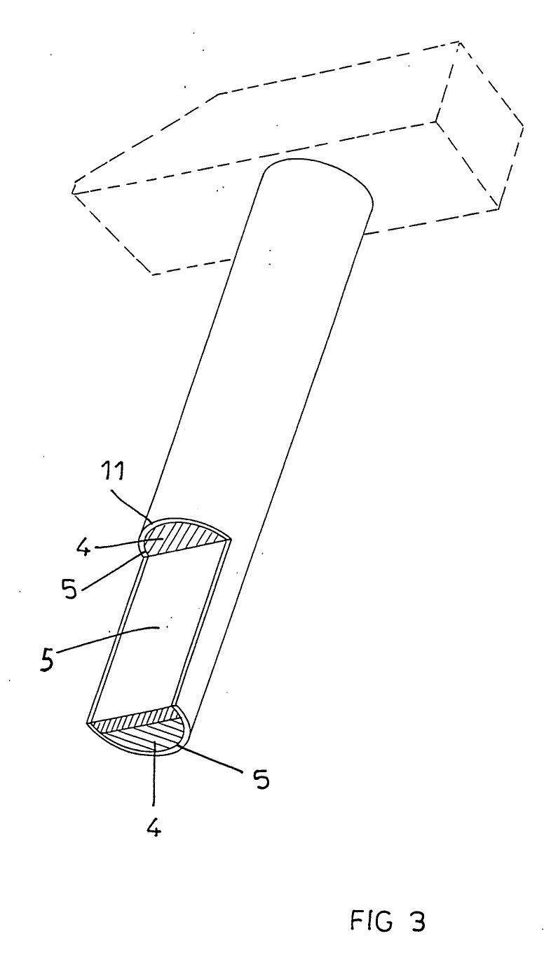

In the case illustrated in FIG. 2, the rod-shaped elements are four in number, and a cross-shaped bearing made from the second material is inserted therebetween.

In this case flexion can occur around all 360° and vibration cushioning will be excellent.

Naturally the configuration of the rod-shaped elements can be of any type according to necessity.

For example, in certain cases the rod-shaped elements could be disks or the like.

The operation of the element with high mechanical resistance and high vibration absorption described in this invention is evident from the descriptions and illustrations.

For example, FIG. 1 shows the head of a hammer in dotted lines and is identified by the reference numeral 15.

When a hammer is used to hit with strong impact, the rod-shaped elements tend to transmit vibrations that are absorbed by the bearing 5, and coating 11.

Moreover, the slight sliding motion is created between the two rod-shaped elements in order to absorb impact further.

The present invention also refers to a method for the realization of an element with high mechanical resistance and high vibration absorption.

The method consists in the automated union without the use of adhesives, of a first material with predominantly high mechanical characteristics with at least one second material with predominantly highly elastic characteristics.

In particular, advantageously, this union is created through chemical bonding that is performed with the application of heat at an established temperature.

In a constructive variant, in the case where the first and second materials are reciprocally incompatible for bonding adhesion, they can be glued together with a chemical bonding adhesive.

In this way a core is formed, that may be eventually coated with at least one third material.

Advantageously, the first material is created using a thermoplastic resin in which a plurality of natural or synthetic fibers are embedded (for example, glass fiber), and the second material is created using an elastomeric polymer, such as thermoplastic polyurethane.

As an example, the first material can be an engineered polyurethane thermoplastic polymer, industrially recognized under the name ETPU (engineering thermoplastic polyurethane) and the second material comprises an elastomeric polymer, preferably polyurethane type.

It has been established that the element with high mechanical strength and high vibration absorption, and the method for implementing the same according to the invention are particularly advantageous because the element is able to absorb vibration very efficiently and the production method is rapid and does not require specialized labor, thus being very cost-effective.

The element with high mechanical resistance and high vibration absorption, and the method for implementing the same according to the invention can be produced with numerous variants and modifications, all of which are included within the scope of the invention; moreover, all components can be replaced by elements that are technically equivalent.

1-24. (canceled)

25. An element having high mechanical strength and high vibration absorption comprising:
an internal core composed of at least one core member constituted of at least one first material consisting of a thermoplastic resin in which a plurality of natural and/or synthetic fibers are embedded and having predominantly high mechanical characteristics, and at least one second material with predominantly highly elastic characteristics bonded to the first material without the use of adhesives; and
a layer covering said core.

26. The element defined in claim 25 wherein said fibers are composed at least in part of glass fiber.

27. The element defined in claim 26 wherein said second material is an elastomeric polymer.

28. The element defined in claim 27 wherein said thermoplastic resin is engineered polyurethane thermoplastic polymer (ETPU).

29. The element defined in claim 27 wherein said second material is composed of thermoplastic polyurethane.

30. The element defined in claim 29 wherein said layer is an elastomeric polymer.

31. The element defined in claim 30 wherein said core is comprised of at least two discrete elongated members of said first material produced by pultrusion and extending along the entire length of said elements, a bearing of said second material being inserted between said elongated elements.

32. The element defined in claim 31 wherein said members are rod-shaped or disk-shaped.

33. The element defined in claim 32 wherein said members are rod-shaped and each have at least one flat surface and one curved surface, said bearing being inserted between and bonded to flat surfaces of said members.

34. The element defined in claim 33 in the form of a handle for a hand tool.

35. A method of making an element with high mechanical strength and high vibration absorption, comprising the steps of:
(a) forming at least two discrete elongated members of a length capable of extending along an entire length of said element and composed of a first material having predominantly high mechanical characteristics;
(b) inserting between said members and automatically bonding thereto by chemical bonding a bearing of at least a second material having predominantly highly elastic characteristics whereby said members and said bearing form a core; and
(c) coating said core with at least one third material.

36. The method defined in claim 35 wherein the bonding of the first material and the second material is effected by the application of heat and without the use of an adhesive.

37. The method defined in claim 36 in which said material is a thermoplastic resin in which a plurality of natural and/or synthetic fibers are embedded.

38. The method defined in claim 37 wherein said fibers include glass fibers.

39. The method defined in claim 38 wherein said second material is a thermoplastic polyurethane.

40. The method defined in claim 39 wherein said thermoplastic resin is engineered polyurethane thermoplastic polymer (EPTU).

41. The method defined in claim 40 wherein said third material is composed of an elastomeric polymer.

42. The method defined in claim 41 wherein said members are shaped at least in part by pultrusion.

43. The method defined in claim 42 wherein said core is shaped at least in part by coextrusion at a temperature sufficient to bond said first and second material together.

44. The method defined in claim 43, further comprising the step of thermoforming said third material to shape said element into an ergonomic shape.
